(19) United States
(12) Patent Application Publication
(10) Pub. No.: US 2022/0090474 A1
(43) Pub. Date: Mar. 24, 2022

(54) SYSTEM AND METHOD FOR FRACTURING

(71) Applicant: Eagle PCO, LLC, Navasota, TX (US)

(72) Inventors: Michael Clark, Montgomery, TX (US); Glendell Hendrix, Magnolia, TX (US); Alfred Homfeld, Humble, TX (US)

(21) Appl. No.: 17/025,854

(22) Filed: Sep. 18, 2020

(51) Int. Cl. E21B 43/26; F16L 3/01; F16L 41/03

(52) U.S. Cl. CPC E21B 43/2607; F16L 41/03; F16L 3/01

(57) ABSTRACT

Apparatus and methods are disclosed for assembling a multi-well fracturing system, and components useful in such a system, and for performing fracturing operations. The multi-well fracturing systems include a skid-based connection assembly including a movable conduit as a switching member between multiple branches of the fracturing system which extend to different wells within the system. Some such systems may include one or more components placed on adjustable skids to facilitate assembly of the fracturing system.

### BACKGROUND

The present description relates generally structures for use in a fracturing system, such as may be used to fracture oil or gas wells; and more specifically relates to an assembly for allowing switching between multiple branches of the fracturing system through use of a movable conduit, and to performing fracturing operations through use of such an apparatus. In various embodiments, the apparatus can be assembled on a movable “skid.”

Fracturing systems as commonly used for operations on wells can include a wide variety of individual components; but generally require an intake manifold (in some configurations referred to as a “goat head”) providing connections with a pumping assembly (which in many cases may involve multiple pumps, such as in the form of pump trucks), and a fracturing manifold that receives fluid from the intake manifold, through a series of connecting blocks, valves, spools, and conduits, and potentially other structures, to a fracturing tree installed on the wellhead. (For purposes of the present description, the term “fracturing components” includes any of connecting blocks, valves, spools, and conduits; but does not exclude other components that might be assembled in combination with such structures). Some fracturing systems include a “zipper” manifold that provides connections to multiple fracturing branches, isolated by valves, so that fracturing fluid/pressure can be redirected from one well to another.

Conventional multi-well fracturing systems, coupled in a zipper manifold configuration, are dependent upon flow control valves to isolate fluid paths to respective wells. During a fracturing operation, the components are subject to high pressures. Such systems can experience leakage of pressure from an active branch of the manifold to inactive branches of the manifold; which is both dangerous and problematic from an operational point of view.

The high pressures used in such zipper multi-well fracturing systems require heavy components, including connection blocks, conduits, and valves, capable of reliably withstanding such pressures. A significant consideration in efficiently performing multi-well fracturing is the significant time required to assemble (“rig up”), and disassemble (“rig down”) the components forming the entire fracturing manifold, including individual branches to respective wellheads, with the branches able to be selectively coupled to the intake manifold. Such assembly time is impacted by the relatively precise positioning required for the heavy components to provide secure mechanical and fluid connections.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A-1B depict, in FIG. 1A, an example fracturing system incorporating a connection skid for facilitating switching between separate manifold branches of the fracturing system, the manifold branches extending to respective wellheads; and in FIG. 1B depicts an expanded view of the connection skid from a first oblique perspective.

FIG. 2 depicts the connection skid of FIG. 1B, illustrated from the opposite side from that figure, and depicted in an oblique perspective.

FIG. 3 depicts partially cutaway view of an example connection of the connection skid.

FIG. 4 depicts an example configuration of a movable conduit as may be utilized in the fracturing system of FIGS. 1A-1B and 2.

FIG. 5 depicts an example configuration of a pin and box telescoping connector constructed as may be used with the movable conduit of FIG. 4.

FIG. 6 depicts an example method of performing fracturing operation as may be performed through use of components as described herein.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The present disclosure addresses a configuration of a fracturing system for multi-well fracturing operations. The assignee of the present application, Eagle PCO, LLC. Has previously filed U.S. patent application Ser. No. 16/843,723, filed Apr. 8, 2020, and claiming the benefit of U.S. provisional applications, Ser. No. 62/831,462, filed Apr. 9, 2019; and 62/932,429, filed Nov. 7, 2019. The disclosure of each of these three identified applications is hereby incorporated by reference for all purposes. Referring for convenience primarily to the above utility application, the application describes a multi-well fracturing system in which a movable conduit is utilized to selectively couple a fluid supply with respective branches leading to the individual wells.

The present disclosure addresses a structure for implementing such a movable fluid path switching assembly described in the form of a movable conduit, selectively movable relative to other components describing a portion of the fluid path assembled on a portable platform. For purposes of the present description, the portable platform will be described in the form of a skid, as is commonly used for land-based fracturing operations. Though the term “skid” as used herein is not so limited, and refers to any movable platform configured to provide a supporting surface for equipment such as that described herein. Common embodiments of such skids include one or more supporting surfaces supported by parallel rails. In some examples, the portable platform is configured to facilitate transport by truck.

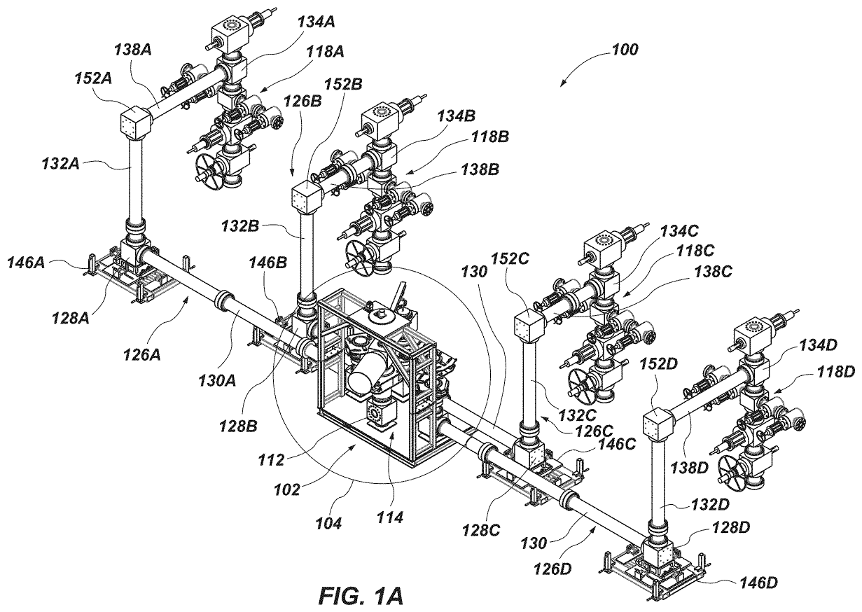

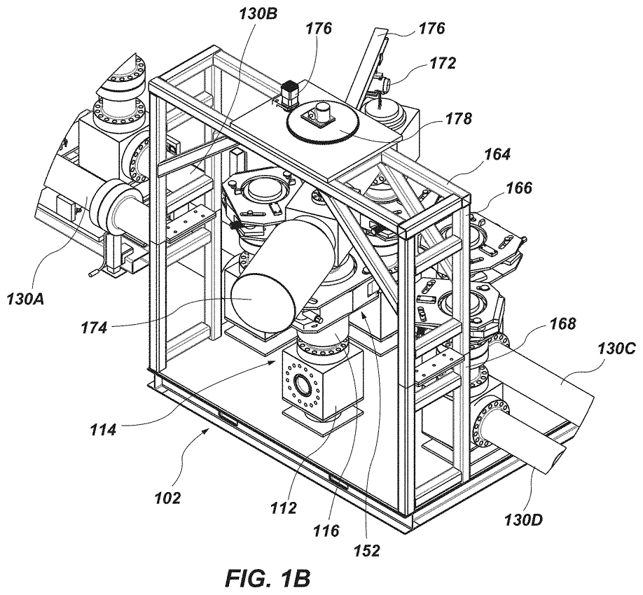

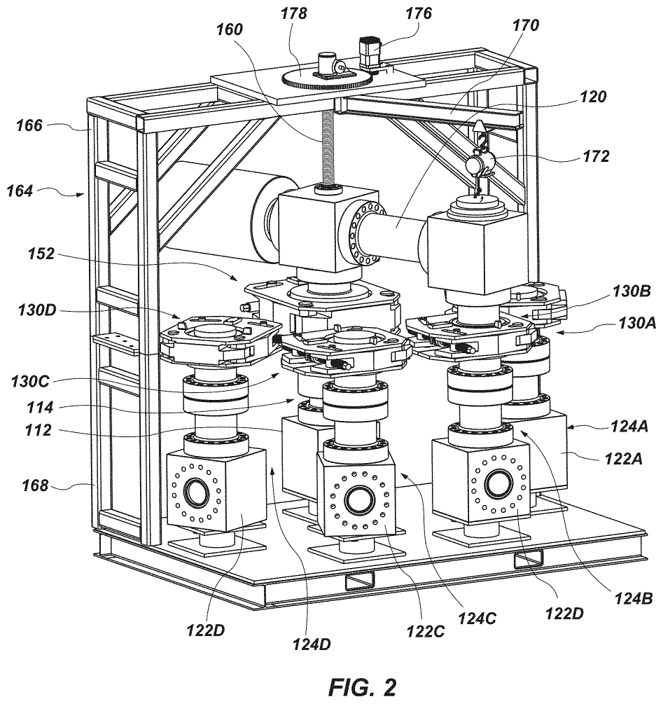

Referring now to the figures in more detail, FIGS. 1A-B depict example components of depicts an example fracturing system 100, in which FIG. 1A depicts an example fracturing system including an example configuration of a connection skid 102 as would be coupled to an intake manifold (or “goat head”) (not depicted). Which will be connected, typically through multiple conduits, to pumping units (not depicted). FIG. 1B depicts connection skid 102 (indicated by circle 104 in FIG. 1A). FIG. 2 depicts an alternate view of connection skid 102, depicted from the opposite side relative to FIGS. 1A-B.

Fracturing system 100 is configured to facilitate sequential fracturing operations on multiple wells. Fracturing system 100 allows the path of the fracturing fluid be directed from one wellhead to another without the use of conventional valves, and therefore without the risk of pressure leakage between the fracturing paths. Fracturing system 100 therefore addresses problems with conventional fracturing systems that include a manifold simultaneously coupled to multiple wellheads, which rely on valves for pressure isolation between fracturing paths, as is common in conventional zipper fracturing manifold configurations. In such zipper fracturing manifold configurations, relatively low flow rates to an isolation valve element (for example, a valve gate) can be insufficient to assure the isolation function of the valve element, allowing pressure to leak from an active branch of the fracturing manifold, to another branch intended to be isolated from that pressure. Such pressure leakage both diminishes the pressure in the active branch and therefore can impair the effectiveness in the fracturing operation, can cause excessive damage to valves and other components, and/or present a safety hazard to workers.

The example fracturing system 100 facilitates assembly of the multiple branches of the fracturing system to wellhead assemblies at multiple wells to be assembled before the fracturing operation (in a manner similar to that achieved with “zipper” configurations). However, instead of relying upon isolation of each branch through a valve, each fracturing manifold branch is coupled to an intake manifold through connection skid 102, which includes an intake connection assembly 114 and multiple distribution assemblies 124A-124D 30 connected to respective wellheads and which may be individually coupled to the intake connection assembly 114 through use of a movable switching conduit 120.

Fracturing systems in accordance with the present disclosure can be configured, in some examples to avoid the use of swivels, as may be prone to leakage and/or damage in the high pressure environment of fracturing operations. The capability of eliminating the requirement of at least some valves and/or swivels simplifies not only assembly and disassembly of the system, but also reduces components susceptible to damage. Additionally, in accordance with the description herein, in some examples, fracturing systems can be configured to reduce the number of blocks required to change direction of the fluid flow (such as 90 degree blocks, as described herein), relative to that required for conventional fracturing systems coupled in a zipper configuration as described earlier herein.

Assembly of a fracturing system such as fracturing system 100 can be assisted, through use of connection skid 102. In selected embodiments, connection skid 102 will include a mounting surface supported by multiple rails of the skid. Example fracturing system 100 is depicted in an example configuration with four manifold branches 126A-D, respectively extending to a respective wellhead assembly 118A-118D, at a respective wellhead, indicated generally at 106A-106D. As will be apparent to persons skilled in the art, the wellhead assemblies 118A-118D each comprise a stack of control equipment for controlling fluids and pressures at the wellhead, such as, for example, control valves, a blowout preventer, etc.

In the depicted example, an outlet from an intake manifold (not depicted) will be coupled through a conduit to a connection block 112 of connection skid 102, in which connection block 112 forms a portion of intake connection assembly 114. Connection block 112 includes a fluid inlet, for example on a side surface, and provides a 90 degree flow path extending to a fluid outlet, such as on the top surface of connection block 112. Intake connection assembly 114, in this example, also includes a connection sub 116 which forms a first portion of a releasable connection assembly, indicated generally at 152, with a movable conduit 120. In some example configurations, the releasable connection assembly can be through a telescoping connection, for example as can be realized in a male/female connector with a first portion of the male/female connector formed in the connection sub, and a second portion of the male/female connector formed on a first end of the movable conduit. Connection sub 116 may be coupled directly to connection block 112, or may be connected through a spool.

In some embodiments, the coupling will be through a relatively quick disconnect connection. As used herein, the term “quick disconnect connection” refers to a mechanical connection for high pressure conduits that can be connected or disconnected more quickly than a bolted flange connection. In some examples, the male/female connector can include a flange on both the male and female connector portions, and the flanges can be coupled to one another through connecting device, such as a clamp 150. As one example, a Grayloc-type clamp, forming a circumferential structure extending around both such flanges, may be used for securing the flanges in secure proximity to one another, establishing the pressure tight connection through the male/female connector, while allowing relatively quick disconnection. In various examples a remotely operated a remotely operated clamp (or other connecting device) may be used to connect components of the quick disconnect connection. While Grayloc is a specific manufacturer of clamps, as well as other equipment; the term “Grayloc-type” is intended to embrace flange clamps from other manufacturers for serving similar purposes, as will be recognized by persons skilled in the art having the benefit of the present disclosure.

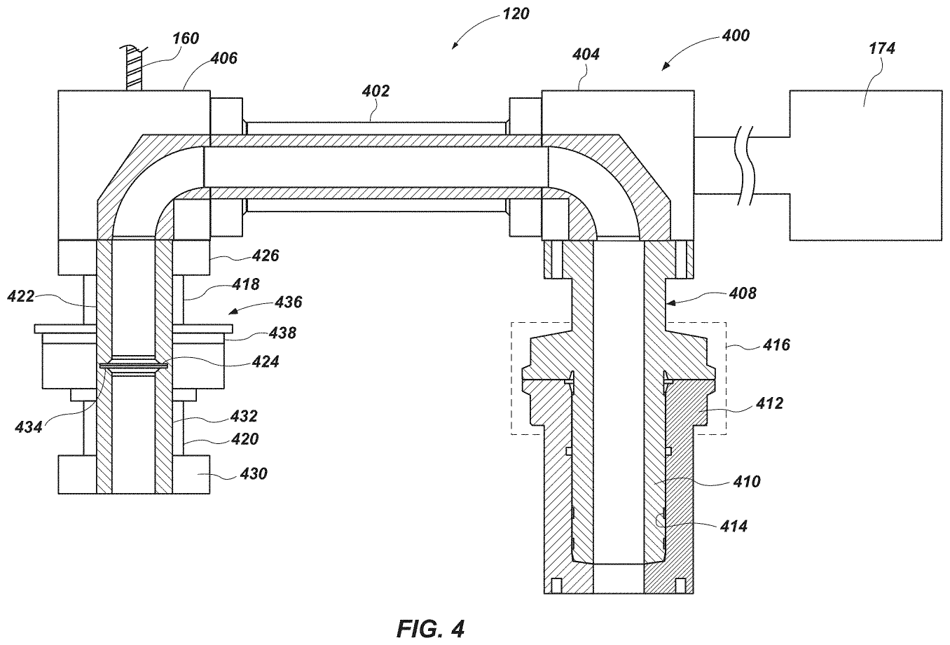

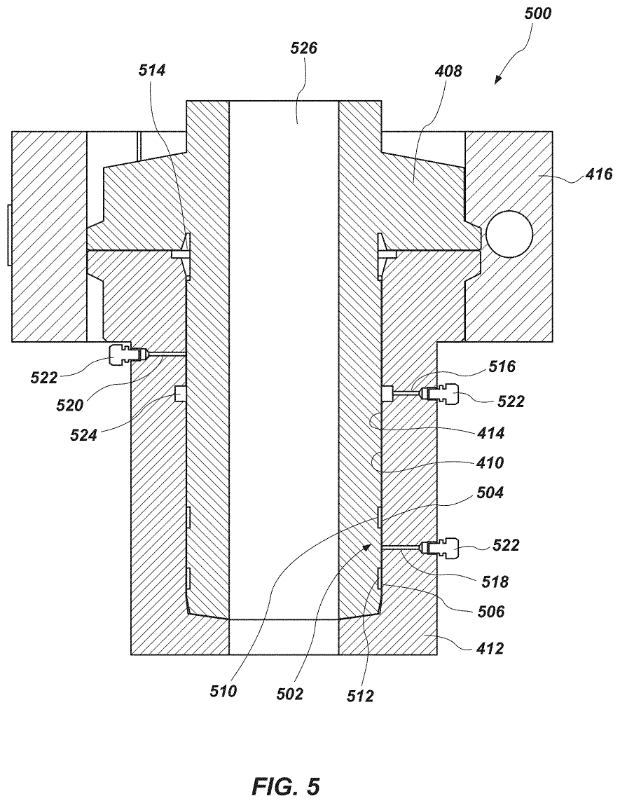

In example fracturing system 100, each manifold branch 126A-126D of the fracturing system extending to a respective wellhead assembly 118A-118D, is connected to a respective distribution assembly 124A-124D mounted on connection skid 102. Distribution assemblies 124A-124D may include multiple components, for example a first portion of a second connection assembly, indicated generally at 130A-130D, to engage a second end of movable conduit 220, as discussed in more detail relative to FIGS. 4 and 5. This first portion of the second connection assembly 130A-130D, may be coupled (in some cases through a spool) in fluid communication with a respective distribution block 122A-122D, facilitating attachment to each manifold branch 126A-126D.

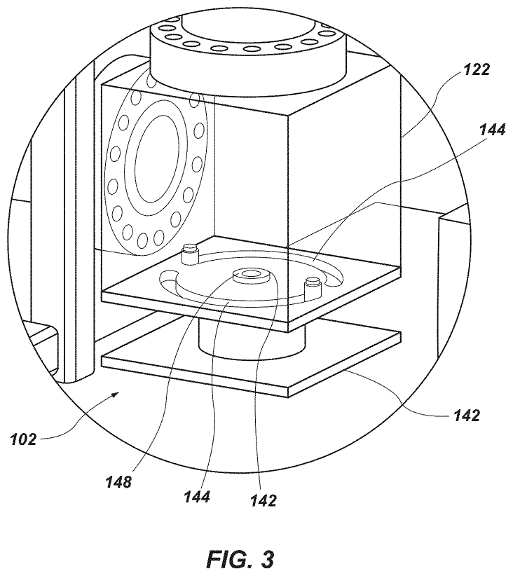

Referring now to FIG. 3, the figure depicts an example mounting structure for mounting each distribution block 122A-122D in connection skid 102. In the depicted example, each distribution block 122 will be mounted on a respective pedestal 142. Each pedestal includes multiple arc-shaped grooves 144 through which each distribution block 122 can be mounted to the supporting pedestal 142. Arc-shaped groove 144 are configured such that distribution block 122 can rotate about a second vertical axis within a range established by the annular dimension of the arc-shaped grooves. Such rotation allows to facilitate flexibility in the paths for each manifold branch assembly 126A-126D. In some embodiments, a bearing recess 146 will be machined into each distribution block 122, to house a supporting bearing 148 centered on the second vertical axis.

The specific design of the manifold branch assemblies 126A-126D will be adapted to the specific configuration needs of the fracturing system, to provide a high pressure fluid path extending from the outlet of a respective distribution block 122A-122D to the wellhead assembly. In the specific example of fracturing system 100, a first conduit 136A-136D extends generally horizontally to couple a respective distribution block 122A-122D on connection skid 102, to a first transition point. In the depicted example, the first transition point includes a 90 degree block 128A-128D to turn the flow path from the horizontal path of first conduit 136A-152D to a vertically extending path through a vertical 132A-132D, which in the depicted example extends generally to a height equal to the vertical location of coupling blocks 134A-134D at the top of each wellhead assembly AA. Another 90 degree block 152A-136D, transitions to a horizontal conduit 138A-138D coupled to coupling blocks 134A-134D. Advantageously, one or more components of the manifold branch assemblies 126A-126D will be placed on adjustable skids, as described in referenced U.S. patent application Ser. No. 16/843,723. In example fracturing system 100, 90 degree blocks 128A-128D which make the transition from horizontal to vertical are each mounted on a respective adjustable skid 146A-146D.

Such adjustable skids include movable platforms providing adjustment relative to two perpendicular axes extending generally relative to a horizontal plane. The use of components mounted on such adjustable skids simplifies alignment of components with one another, and also facilitates lateral movement of components as may be useful in assembling and disassembling the fracturing system, as well as in replacing individual components of the fracturing system. Generally, the adjustable skids include two supporting structures, of which a first structure is movable along a first (“X”) axis relative to the skid; and the second structure is supported above the first structure and is movable along a second (“Y”) axis relative to the skid. Various forms of drivers (or “prime movers,” as the terms are used herein interchangeably) may be utilized to cause motion along the respective axes. In some example embodiments, opposing pneumatic jacks having a capacity of about 20 tons may be utilized. In other configurations, hydraulic jacks or other prime movers could be utilized; and/or electrically driven motors or other prime movers may be utilized.

In fracturing system 100, the distribution blocks 122A-122D of connection skid 102 are coupled to each manifold branch 126A-126D. To facilitate precise placement of each the distribution block 122A-122D such that the first portion of the second connection assemblies 130A-130D of the respective distribution assemblies 124A-124D is placed to engage with movable conduit 120, each distribution block 122A-122D will be placed at the same radius relative to a first vertical axis through the first connection assembly at the opposite end of movable conduit 120. As an example of scale, in some examples the radius may be, for example, less than 60 inches, in one example, approximately 58 inches. This precise spacing allows movable conduit 120 to be moved to switch the fluid flow path from intake manifold 108 to any of distribution blocks 122A-122D and thus to any manifold branch 126A-126B. When movable conduit 120 is placed into engagement between intake connection assembly 114 and a respective distribution assembly 124A-124D, the movable conduit will be secured in position relative to intake connection assembly 114, and also to the respective distribution assembly 124A-124D. In view of the close spacing tolerances required for forming secure a sealing engagement between movable conduit 120 and both intake connection assembly 114 and each distribution assembly 124A-124D, positioning and securing these components to a common skid through use of structures that are at least partially self orienting (as discussed relative to the mountings of distribution blocks 122A-122D, for example) simplifies the positioning operation and eliminates or at least reduces the trial and error of positioning the distribution assemblies relative to the rotational path of movable conduit 120. Additionally, because the described components are all supported by connection skid 102 such positioning of components can be done away from the fracturing location, even before transport of connection skid 102 to the fracturing location; again, reducing the amount of time required to assemble the entire fracturing system.

As is apparent from the preceding discussion, movable conduit 120 will be rotated around an axis relative to connection sub 116 of intake connection assembly 114 to make connection with a selected distribution assembly 124A-D. As identified above, this connection will preferably use a telescoping connector. Example connectors to engage each end of movable conduit 120 are discussed in more detail relative to FIGS. 4 and 5. As a result, to facilitate movement of movable conduit 120 to engage a selected distribution assembly, a lift mechanism may be provided to raise movable conduit 120 relative to intake connection assembly 114 and distribution assemblies 126A-126D, to facilitate that movement. In various embodiments, the lift may move movable conduit either by pushing it upward, such as through a jack or similar mechanism, or by pulling it upward. The depicted embodiment uses the latter approach. Using a screw jack, in which a threaded shaft 160 is coupled to movable conduit 120 and wherein an electric drive assembly 176, for example, may be used to rotate a drive boss 178 engaged with threaded shaft 160 to vertically position movable conduit 120.

Accordingly, connection skid 102 includes a support frame 164 that extends up and across at least a portion of the skid; most importantly across the first end of the movable conduit which engages the intake connection assembly. In selected embodiments, to facilitate transportation, at least an uppermost portion of the support frame 166 may be detachable from a lower portion 168 coupled to the skid base. In some embodiments, the uppermost portion of the support frame may be detachable along with movable conduit 120 minimize the height for transport.

As is apparent from the figures, the distal end of the movable conduit 120 extends at a distance away from the first vertical axis of rotation at the connection sub 116. In the depicted example embodiment, support frame 164 includes a boom 170 rotational relative to support frame 164, to assist in supporting the outermost end of movable conduit 120. In the depicted embodiment, boom 170 connects through an adjustable mechanism, such as an electric or manual hoist 172. Additionally, in order to ease movement of movable conduit 120, and reduce the magnitude of sideloading through the first connection assembly, a counterweight 174 is coupled on the opposite side of the axis of rotation of movable conduit 120

In fracturing system 100, the manifold branch assemblies 126A-126D are laid out in an example configuration, with distribution assemblies 126A-126B, having outlets extending in a first direction; and with distribution assemblies 126C-126D, having outlets extending in a second direction, opposite the first direction. This arrangement can simplify assembly of the fracturing system, as first conduits 136A-136B can extend parallel to one another in a first direction; while first conduits 1360-136D also extend parallel to one another in an opposite direction. Though, as discussed above relative to FIG. 3, the depicted example connection skid 102 facilitates other layouts through alternative orientation of distribution blocks 122A-122D.

Referring now to FIG. 4, the figure depicts an example configuration of a movable conduit 400, with connection structures at each end, as an example configuration for movable conduit 120 of FIGS. 1A-1B and 2. Movable conduit 400 includes a central conduit 402, with a first 90 degree block 404 at a first end, and a second 90 degree block 406 at a second end. A pin connector 408 is coupled to block 404, and includes an extension 410 forming a male portion of a first male/female connector. The mating (female) box connector 412 (as an example embodiment of connection sub 116 of fracturing system 100), intake connection assembly 114, includes a receiving bore 414, and is depicted in engagement with extension 410, in an operating engagement. In some example systems, pin connector 408 will be maintained in secure engagement with box connector 412 by a connecting structure 416 (schematically represented by dashed lines), for example a conventional Grayloc-type clamp, as known to persons skilled in the art. Other suitable connecting mechanisms known to persons skilled in the art may be used in place of the Grayloc-type clamp; and in some instances, a remotely operable clamping mechanism may be used. Also, as will be apparent to persons skilled in the art, and as will be discussed in relation to FIG. 5, sealing mechanisms will be included on one or both of pin connector 408 and box connector 412 to assure a pressure and fluid-tight connection.

In some examples, a similar pin and box or male/female connector, or another form of telescoping connector, may be used on the second end of movable conduit 400. In some example systems, the connector at the second end of movable conduit 400 will be shorter (i.e. will extend a lesser distance beneath block 406, than pin connector 408). That configuration will allow pin extension 410 to remain in general engagement within receiving bore 414 while movable conduit is being rotated from engagement with a first distribution block to engagement with a second distribution block, as described relative to the preceding figures.

As an example of such connector, movable conduit 400 includes a flush joint connection assembly 436. In the example configuration, flush joint connection assembly includes an upper member 418 and a lower member 420. Upper member 418 is configured to bolt to block 406 through a flange 426, and includes a conduit 422 terminating at a flat surface 424. Upper member 418 will include a circumferential flange adjacent flat surface 424 as is familiar to persons skilled in the art (these flanges within connector 438, and are comparable to those depicted in cross-section on members 408 and 412, coupled by connecting structure 416 (there depicted in phantom). Lower member 420 is configured to couple to a distribution block (122A-122D) in FIGS. 1A-1B, and 2) through flange 430 (such coupling can be either direct or through a spool), and includes a conduit 432 terminating at a flat surface 434. Lower member 420 again includes a circumferential flange (not depicted) adjacent flat surface 434. When placed in an operating configuration, as shown, flat surfaces of members 420 and 434 are placed adjacent one another, separated by a seal assembly suitable for a high pressure environment, and the two members 418 and 420 are secured in position by a connecting device 438, for example a Grayloc-type clamp, which engages the circumferential flanges on upper member 418 and lower member 420. Again, in some examples, a remotely operable clamp (or other connecting device) can be used.

Referring now to FIG. 5, the figure indicates an example configuration of a pin and box telescoping connector 500, facilitating pressure integrity verification. Pin and box connector 500 may be implemented as a quick disconnect connector and is an example configuration that may be incorporated as the male/female connector of movable conduit 400 and intake connection assembly 114. For purposes of the present example, structures that correspond to those discussed relative to movable conduit 400 are numbered similarly relative to telescoping connector 500, and thus the basic mechanical structure and operation of the connector will not be repeated here. In connector 500, a sealing structure, as indicated generally at 502, is supported by extension 410 of pin connector 408. Sealing structure 502 is configured to provide a pressure and fluid-tight seal under the pressures of a fracturing operation (which require elevated pressures, for example in the vicinity of 15,000 psi). In the example of connector 500 sealing structure 502 includes two separate seals 504, 506 vertically separated by an intermediate region. One or both of seals 504, 506 may be an elastorneric seal, such as a suitable material and size of O-ring (such as a slotted groove O-ring) retained within a respective circumferential recess 510, 512 in extension 410. Other forms of elastomeric or other compressible/expandable seal structures may be utilized, for example chevron seals, and other seal configurations known to persons skilled in the art.

Connector 500 also includes a seal ring 514 establishing a metal-to-metal seal between pin connector 408 and box connector 412. A particular capability of connector 500 is to provide the ability to verify the integrity of the seal structure between extension 410 and receiving bore 414. As a result, a first pressure monitoring port 516 is formed extending to engage receiving bore 414 at a first position above sealing structure 502. Connector 500 also includes a second pressure monitoring port 518 extending to engage receiving bore at a location which will be adjacent the intermediate region when extension 410 is fully engaged within receiving bore 414. Additionally, example connector 500 further includes a third pressure monitoring port 520 on the opposite side of the sealing structure 502 from the first pressure monitoring port 516. As will be appreciated by persons skilled in the art having the benefit of this disclosure, the use of three pressure monitoring ports arranged as described relative to the sealing structure allows verification of the integrity of the pressure seal within connector 500, and including verification of the integrity of each of the two spaced seals 504, 506. Additionally, in the depicted example pressure monitoring port 516 extends to a circumferential recess 524 formed in the sidewall of receiving bore 414. In the event that a defect in integrity is identified, a further pressure sealant may be pumped through pressure monitoring port 516 to recess 524 to restore pressure integrity through the connector 500, such that no fluid or pressure leaks from central bore 526 through connector 500 under fracturing conditions. When not in use, each pressure port will be capped by a respective high pressure plug 522.

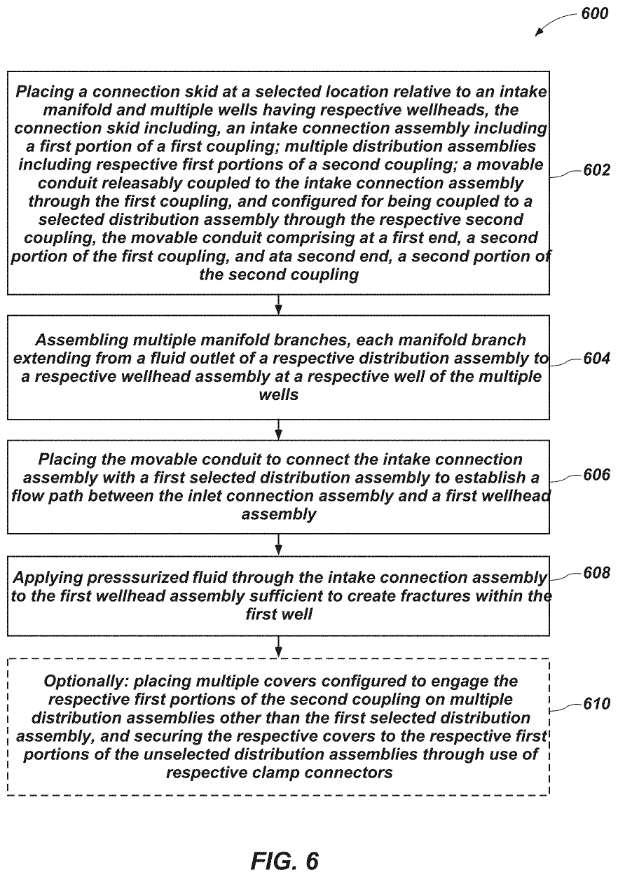

Referring now to FIG. 6, the figure depicts an example method 600 of performing a multi-well fracturing operation. The fracturing system will need to be assembled based upon the placement of the multiple wells to be fractured in the placement of other components. In accordance with the described systems described above, has indicated 602 assembling the system will include placing a connection skid (for example as described relative to FIGS. 1-5) at a selected location relative to an intake manifold (or an anticipated location for the intake manifold) and the multiple wells to be perforated. As described above, the connection skid will include an intake connection assembly including a first portion of a first company; and multiple distribution assemblies including respective portions of a second coupling. Additionally, the above-described movable conduit will be releasably couple to the intake connection assembly through the first coupling into a selected distribution assembly through the respective second coupling, in which the movable conduit includes, at a first end, a second portion of the first coupling, and a second end a second portion of the second company.

Additionally, as indicated at 604 multiple manifold branches will be assembled, each extending to the wellhead assembly of a respective well. As described above, the manifold branches will couple to the distribution assemblies of the connection skid.

As indicated 606, the movable conduit will be placed to connect the intake connection assembly with a first selected distribution assembly; and may be secured in place through use of the first and second couplings as described previously herein.

As indicated 608, pressurized fluid will be applied through the intake connection assembly to the first wellhead assembly, under conditions sufficient to create fractures within the first well.

As optionally indicated at 610, individual covers may desirably be placed to engage the second coupling members of the non-selected distribution assemblies. An example configurations, the covers may be maintained in such engagement through use of clamping devices, for example Grayloc-type clamping devices engaging flanged surfaces of the respective cover and the first portion of the second coupling of the distribution assembly.

The following non-limiting Examples are provided as further description of the example embodiments of the described subject matter.

Example 1 is a fracturing system having a movable fluid path switching assembly, comprising: a skid assembly, including, an intake connection assembly configured to receive pressurized fracturing fluid from an intake manifold, the intake connection assembly comprising a first portion of a first quick disconnect coupling; multiple distribution assemblies comprising a respective first portion of a second quick disconnect coupling, and further comprising a respective fluid outlet; and a movable conduit releasably coupled to the intake connection assembly through the first quick disconnect coupling, and configured for being coupled to a selected distribution assembly of the multiple distribution assemblies through the respective second quick disconnect coupling of the selected distribution assembly, the movable conduit comprising, at a first end, a second portion of the first quick disconnect coupling configured to establish a fluid coupling with the fluid outlet of the intake connection assembly; and at a second end, a second portion of the second quick disconnect coupling is configured to establish a fluid coupling with the distribution assembly.

In Example 2, the subject matter of Example 1 wherein the first quick disconnect coupling comprises a male/female connector.

In Example 3, the subject matter of Example 2 optionally includes: wherein the first portion of the first quick disconnect coupling is a female portion of the male/female connector and includes a receiving bore; wherein the second portion of the first quick disconnect coupling comprises a pin connection; and wherein the pin connection is configured to sealingly engage within the receiving bore.

In Example 4, the subject matter of any one or more of Examples 1-3 optionally include: wherein the second quick disconnect coupling comprises a flush joint connection assembly; wherein the first portion of the second quick disconnect coupling of the distribution assembly comprises a first connector having a first flat engaging surface and wherein a second portion of the second quick disconnect coupling comprises a second connector having a second flat engaging surface; and wherein the first and second flat engaging surfaces each engage opposing surfaces of a seal structure.

In Example 5, the subject matter of any one or more of Examples 1-4 wherein the intake connection assembly comprises a connection block configured to be coupled to an intake manifold, the connection block coupled to the first portion of the first quick disconnect coupling.

In Example 6, the subject matter of Example 5 wherein the first quick disconnect coupling further comprises a clamp connector securing the first and second portions of the first quick disconnect coupling in a fixed position.

In Example 7, the subject matter of any one or more of Examples 4-6 wherein the second quick disconnect coupling further comprises a clamp connector securing the first and second connectors of the second quick disconnect coupling in a fixed position.

In Example 8, the subject matter of Example 7 optionally includes multiple covers, each configured to sealingly engage a respective first portion of the second quick disconnect coupling of the multiple distribution assemblies.

In Example 9, the subject matter of any one or more of Examples 3-8 wherein the second quick disconnect coupling can be released and the first and second portions of the second quick disconnect coupling separated from one another while the pin connection of the first quick disconnect coupling remains at least partially within the receiving bore.

In Example 10, the subject matter of Example 9 wherein the movable conduit is rotatable along a first generally vertical axis, and wherein the multiple distribution assemblies are coupled to the skid with the respective second quick disconnect couplings placed at a common radius relative to the first vertical axis.

In Example 11, the subject matter of Example 10 wherein the multiple distribution assemblies each include a respective outlet block configured for coupling to a respective branch of the fracturing manifold; and wherein each outlet block is coupled to the skid through an interconnection allowing rotation of the respective outlet block within an established range relative to the skid.

In Example 12, the subject matter of any one or more of Examples 1-11 wherein the skid further comprises a lift assembly coupled to the movable conduit, and configured to raise the movable conduit relative to the intake connection assembly to allow connection of the movable conduit to a selected distribution assembly.

In Example 13, the subject matter of Example 12 wherein the skid further comprises a support frame extending above the movable conduit, and wherein the lift assembly comprises a jackscrew coupled to the movable conduit, and rotatable by a drive assembly supported by the support frame.

In Example 14, the subject matter of Example 13 wherein the jackscrew is coupled along a first vertical axis of rotation of the movable conduit relative to the intake connection assembly.

In Example 15, the subject matter of Example 14 optionally includes a support arm coupled to the support frame, the support arm coupled to the movable conduit at a location distal from the first vertical axis of rotation.

In Example 16, the subject matter of any one or more of Examples 1-15 wherein the skid further comprises a support frame extending above at least a portion of the fracturing manifold.

In Example 17, the subject matter of Example 16 wherein an upper portion of the support frame is detachable from a lower portion of the support frame which extends from the skid.

In Example 18, the subject matter of Example 17 wherein the upper portion of the support frame supports at least a portion of a lift mechanism coupled to the movable conduit.

In Example 19, the subject matter of any one or more of Examples 3-18 wherein the receiving bore is in communication with multiple pressure access ports.

In Example 20, the subject matter of Example 19 wherein at least one of the multiple pressure access ports extends to a location between first and second seals on the pin connection, when the first and second portions of the quick disconnect coupling are secured together.

In Example 21, the subject matter of any one or more of Examples 19-20 wherein a first of the multiple pressure access ports extends to a location on a first side of a sealing structure between the pin connection and the receiving bore.

In Example 22, the subject matter of Example 21 wherein a second of the multiple pressure access ports extends to a location on a second side of the sealing structure between the pin connection and the receiving bore.

In Example 23, the subject matter of Example 22 wherein the sealing structure comprises two seals separated by an intermediate area, and wherein a third of the multiple pressure access ports extends to the intermediate area between the two seals.

Example 24 is a multi-well fracturing system, comprising: an intake manifold, including, multiple inlet connections configured for receiving fracturing fluid under pressure and conveying the received fracturing fluid to a fluid outlet during a fracturing operation; a connection skid, including, an intake connection assembly configured to receive pressurized fracturing fluid from the intake manifold, the connection assembly comprising a first portion of a first coupling; multiple distribution assemblies comprising a respective first portion of a second coupling, and further comprising a respective fluid outlet; and a movable conduit releasably coupled to the intake connection assembly through the first coupling, and configured for being coupled to a selected distribution assembly of the multiple distribution assemblies through the respective second coupling of the selected distribution assembly, the movable conduit comprising, at a first end, a second portion of the first coupling configured to establish a fluid coupling with the fluid outlet of the intake connection assembly; and at a second end, a second portion of the second coupling is configured to establish a fluid coupling with the distribution assembly; multiple fracturing manifold branches, each branch coupled to the respective fluid outlet of the multiple distribution assemblies, and wherein each fracturing branch extends to a respective wellhead connection assembly.

In Example 25, the subject matter of Example 24 wherein the movable conduit is rotatable between a first position establishing communication with a first distribution assembly coupled to a first fracturing branch, and a second position establishing communication with a second distribution assembly coupled to a second fracturing branch.

In Example 26, the subject matter of any one or more of Examples 24-25 wherein each fracturing branch of the multiple fracturing branches in fluid communication with the intake manifold only when the movable conduit is coupled to the distribution assembly of the respective fracturing branch.

In Example 27, the subject matter of any one or more of Examples 24-26 wherein the intake connection assembly comprises a first portion of a first quick disconnect coupling at the fluid outlet.

In Example 28, the subject matter of any one or more of Examples 24-27 wherein one or more components of at least one of the multiple fracturing branches are supported on an adjustable assembly of a second skid, the second skid further including, a skid frame supporting the adjustable assembly, a first structure secured in movable relation to the skid frame, the first structure movable along a first axis, and a second structure secured in movable relation to the skid frame, the second structure movable along a second axis extending generally perpendicular to the first axis.

In Example 29, the subject matter of Example 28 optionally includes at least one first prime mover configured to move the first structure relative to the first axis.

In Example 30, the subject matter of Example 29 optionally includes at least one second prime mover configured to move the second structure relative to the second axis.

In Example 31, the subject matter of Example 30 wherein the at least one first prime mover comprises two movers in opposing relation to one another, each mover configured to move the first structure in a respective direction relative to the first axis.

Example 32 is a method of performing a multi-well fracturing operation, comprising: assembling a fracturing system, comprising, placing an intake manifold at a selected location relative to multiple wells, the intake manifold including multiple inlet connections configured for receiving fracturing fluid under pressure to fluid outlet during a fracturing operation, placing a connection skid at a selected location relative to at least the intake manifold, the connection skid including, an intake connection assembly configured to receive pressurized fracturing fluid from the intake manifold, the connection assembly comprising a first portion of a first coupling; multiple distribution assemblies comprising a respective first portion of a second coupling, and further comprising a respective fluid outlet; and a movable conduit releasably coupled to the intake connection assembly through the first coupling, and configured for being coupled to a selected distribution assembly of the multiple distribution assemblies through the respective second coupling of the selected distribution assembly, the movable conduit comprising, at a first end, a second portion of the first coupling configured to establish a fluid coupling with the fluid outlet of the intake connection assembly, and at a second end, a second portion of the second coupling is configured to establish a fluid coupling with the distribution assembly; and assembling multiple fracturing branches, each fracturing branch extending from the fluid outlet of a respective distribution assembly to a respective wellhead assembly at a respective well of the multiple wells; and placing the movable conduit to connect the intake connection assembly with a first selected distribution assembly to establish a flow path between the inlet connection assembly and a first wellhead assembly in communication with the first selected distribution assembly.

In Example 33, the subject matter of Example 32 wherein placing the movable conduit to connect the intake connection assembly with a first selected distribution assembly comprises securing the first and second portions of the second coupling in sealing engagement through use of a Grayloc-type clamp.

In Example 34, the subject matter of Example 33 optionally includes placing multiple covers configured to engage the respective first portions of the second coupling on multiple distribution assemblies other than the first distribution assembly, and securing the respective covers to the respective first portions through use of respective clamp connectors.

In Example 35, the subject matter of any one or more of Examples 32-34 optionally include performing a fracturing operation on the first well; and after completing the fracturing operation on the first well, disengaging the movable conduit from the first selected distribution assembly, and moving the movable conduit into engagement with a second selected distribution assembly to establish a flow path between the inlet connection assembly and a second wellhead assembly in communication with the second selected distribution assembly.

In Example 36 any of the connectors or couplings of any of Examples 1-35 can be quick release connectors or couplings.

In Example 37 any of the apparatus of any of Examples 1-31 may be adapted to perform any of the methods of any of Examples 32-35.

In Example 38, any of the methods of any of Examples 32-35 may be adapted for use with any of the apparatus of any of Examples 1-31.

In Example 39 any of the apparatus of Examples 1-31 may be adapted to include a structure or feature set forth in any other of such Examples.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A fracturing system having a movable fluid path switching assembly, comprising:
a skid assembly, including,
an intake connection assembly configured to receive pressurized fracturing fluid from an intake manifold, the intake connection assembly comprising a first portion of a first coupling;
multiple distribution assemblies comprising a respective first portion of a second coupling, and further comprising a respective fluid outlet; and
a movable conduit releasably coupled to the intake connection assembly through the first coupling, and configured for being coupled to a selected distribution assembly of the multiple distribution assemblies through the respective second coupling of the selected distribution assembly, the movable conduit comprising,
at a first end, a second portion of the first quick disconnect coupling configured to establish a fluid coupling with the fluid outlet of the intake connection assembly; and
at a second end, a second portion of the second quick disconnect coupling is configured to establish a fluid coupling with the distribution assembly.

2. The fracturing system of claim 1, wherein the first coupling comprises a male/female connector.

3. The fracturing system of claim 2:
wherein the first portion of the first coupling is a female portion of the male/female connector and includes a receiving bore;
wherein the second portion of the first coupling comprises a pin connection; and
wherein the pin connection is configured to sealingly engage within the receiving bore.

4. The fracturing system of claim 1:
wherein the second coupling comprises a flush joint connection assembly;
wherein the first portion of the second coupling of the distribution assembly comprises a first connector having a first flat engaging surface and wherein a second portion of the second coupling comprises a second connector having a second flat engaging surface; and
wherein the first and second flat engaging surfaces each engage opposing surfaces of a seal structure.

5. The fracturing system of claim 1, wherein the intake connection assembly comprises a connection block configured to be coupled to an intake manifold, the connection block coupled to the first portion of the first quick disconnect coupling.

6. The fracturing system of claim 5, wherein the first coupling further comprises a clamp connector securing the first and second portions of the first quick disconnect coupling in a fixed position.

7. The fracturing system of claim 4, wherein the second coupling further comprises a clamp connector securing the first and second connectors of the second coupling in a fixed position.

8. The fracturing system of claim 7, further comprising multiple covers, each configured to sealingly engage a respective first portion of the second coupling of the multiple distribution assemblies.

9. The fracturing system of claim 3, wherein the second coupling can be released and the first and second portions of the second coupling separated from one another while the pin connection of the first coupling remains at least partially within the receiving bore.

10. The fracturing system of claim 9, wherein the movable conduit is rotatable along a first generally vertical axis, and wherein the multiple distribution assemblies are coupled to the skid with the respective second quick disconnect couplings placed at a common radius relative to the first vertical axis.

11. The fracturing system of claim 10, wherein the multiple distribution assemblies each include a respective outlet block configured for coupling to a respective branch of the fracturing manifold; and wherein each outlet block is coupled to the skid through an interconnection allowing rotation of the respective outlet block within an established range relative to the skid.

12. The fracturing system of claim 1, wherein the skid further comprises a lift assembly coupled to the movable conduit, and configured to raise the movable conduit relative to the intake connection assembly to allow connection of the movable conduit to a selected distribution assembly.

13. The fracturing system of claim 12, wherein the skid further comprises a support frame extending above the movable conduit, and wherein the lift assembly comprises a jackscrew coupled to the movable conduit, and rotatable by a drive assembly supported by the support frame.

14. The fracturing system of claim 1, wherein the skid further comprises a support frame extending above at least a portion of the movable conduit.

15. The fracturing system of claim 14, wherein an upper portion of the support frame is detachable from a lower portion of the support frame which extends from the skid.

16. The fracturing system of claim 15, wherein the upper portion of the support frame supports at least a portion of a lift mechanism coupled to the movable conduit.

17. A multi-well fracturing system, comprising:
a connection skid, including, an intake connection assembly configured to receive pressurized fracturing fluid from the intake manifold, the connection assembly comprising a first portion of a first coupling;
multiple distribution assemblies comprising a respective first portion of a second coupling, and further comprising a respective fluid outlet; and
a movable conduit releasably coupled to the intake connection assembly through the first coupling, and configured for being coupled to a selected distribution assembly of the multiple distribution assemblies through the respective second coupling of the selected distribution assembly, wherein,
at a first end of the movable conduit, a second portion of the first coupling configured to establish a fluid coupling with the fluid outlet of the intake connection assembly; and
at a second end of the movable conduit, a second portion of the second coupling is configured to establish a fluid coupling with the distribution assembly; and
multiple fracturing manifold branches, each branch coupled to the respective fluid outlet of the multiple distribution assemblies, and wherein each fracturing branch extends to a respective wellhead connection assembly.

18. The multi-well fracturing system of claim 17, wherein the movable conduit is rotatable between a first position establishing communication with a first distribution assembly coupled to a first fracturing branch, and a second position establishing communication with a second distribution assembly coupled to a second fracturing branch.

19. The multi-well fracturing system of claim 17, wherein each fracturing branch of the multiple fracturing branches in fluid communication with the intake manifold only when the movable conduit is coupled to the distribution block of the respective fracturing branch.

20. A method of performing a multi-wellfracturing operation, comprising:
assembling a fracturing system, comprising,
placing an intake manifold at a selected location relative to multiple wells, the intake manifold including multiple inlet connections configured for receiving fracturing fluid under pressure to fluid outlet during a fracturing operation,
placing a connection skid at a selected location relative to at least the intake manifold, the connection skid including,
an intake connection assembly configured to receive pressurized fracturing fluid from the intake manifold, the connection assembly comprising a first portion of a first coupling;
multiple distribution assemblies comprising a respective first portion of a second coupling, and further comprising a respective fluid outlet; and
a movable conduit releasably coupled to the intake connection assembly through the first coupling, and configured for being coupled to a selected distribution assembly of the multiple distribution assemblies through the respective second coupling of the selected distribution assembly, the movable conduit comprising,
at a first end, a second portion of the first coupling configured to establish a fluid coupling with the fluid outlet of the intake connection assembly, and
at a second end, a second portion of the second coupling is configured to establish a fluid coupling with the distribution assembly;
assembling multiple fracturing branches, each fracturing branch extending from the fluid outlet of a respective distribution assembly to a respective wellhead assembly at a respective well of the multiple wells; and
placing the movable conduit to connect the intake connection assembly with a first selected distribution assembly to establish a flow path between the inlet connection assembly and a first wellhead assembly in communication with the first selected distribution assembly.

21. The method of claim 20, wherein placing the movable conduit to connect the intake connection assembly with a first selected distribution assembly comprises securing the first and second portions of the second coupling in sealing engagement through use of a Grayloc clamp.

22. The method of claim 21, further comprising placing multiple covers configured to engage the respective first portions of the second coupling on multiple distribution assemblies other than the first distribution assembly, and securing the respective covers to the respective first portions through use of respective clamp connectors.

23. The method of claim 20, further comprising:
performing a fracturing operation on the first well; and
after completing the fracturing operation on the first well, disengaging the movable conduit from the first selected distribution assembly, and moving the movable conduit into engagement with a second selected distribution assembly to establish a flow path between the inlet connection assembly and a second wellhead assembly in communication with the second selected distribution assembly.
